(19) United States
(12) Patent Application Publication
(10) Pub. No.: US 2009/0208818 A1
(43) Pub. Date: Aug. 20, 2009

(54) BATTERY CELL FUEL GAUGE FOR PACKAGED BATTERIES AND ASSOCIATED SYSTEMS AND METHODS

(75) Inventor: Spencer Poff, Aloha, OR (US)

Correspondence Address: PERKINS COIE LLP;PATENT-SEA, P.O. BOX 1247, SEATTLE, WA, 98111-1247, US

(73) Assignee: MicroPower Electronics, Inc., Beaverton, OR (US)

(21) Appl. No.: 12/371,418

(22) Filed: Feb. 13, 2009

Related U.S. Application Data
(60) Provisional application No. 61/028,606, filed on Feb. 14, 2008.

(51) Int. Cl. H01M 10/48

(52) U.S. Cl. 429/50; 429/90; 429/92

(57) ABSTRACT

The present disclosure is directed generally to battery cell fuel gauges for packaged batteries and associated systems and methods. A method in accordance with one embodiment includes detecting one or more parameters corresponding to one or more battery cells that are disposed within a casing of a battery packet with a fuel gauge that is also disposed within the casing and that is electrically coupled to a data connector that is accessible from outside the casing. The method can further include formatting the detected one or more parameters into a data file that is readable with non-proprietary hardware and/or software, e.g., via a USB cable. The data file is stored at the fuel gauge. The method can still further include providing a host device with access to the data file via the data connector.

### CROSS-REFERENCE TO RELATED APPLICATION

This application claims priority to U.S. Provisional Application No. 61/028,606, which is incorporated herein by reference.

### TECHNICAL FIELD

The present disclosure is related to packaged battery devices including battery cell fuel gauges for measuring battery cell parameters and methods of manufacturing such battery packages.

### BACKGROUND

Many portable electronic devices employ a battery package in lieu of conventional batteries or conventional battery arrangements. Existing battery packages are rechargeable and customizable, and typically include an array of rechargeable battery cells, circuitry for monitoring and regulating output power, and a casing that houses the battery cells and battery circuitry. Accordingly, battery packages can be tailored so that (a) the battery cells meet specific power requirements, (b) the package circuitry provides power feedback and control, and (c) the package casing protects the package cells and circuitry from various environmental factors. For example, battery cells for portable medical equipment (e.g., defibrillators, portable X-ray devices, and insulin pumps) are designed to meet stringent power tolerances.

Despite the foregoing advantages, battery packages are more complex than conventional batteries and can therefore be more prone to failure or diminishing performance. For example, if an individual battery cell fails, this event can cause other battery cells within the package to rapidly discharge, resulting in overheating. If the battery cells are recharged too frequently, they may store successively less charge at each charge cycle, reducing the amount of energy that a battery package can provide. Because battery packages are more expensive than disposable batteries, however, it can be more cost effective in several instances to repair a failed or underperforming battery package than to replace it with a new battery package. Unfortunately, endpoint-users or consumers of battery packages are not equipped to readily assess battery package failure modes.

### BRIEF DESCRIPTION OF THE DRAWINGS

FIG. 1 is a partially cut-away, isometric view of a battery package having a battery cell fuel gauge configured in accordance with an embodiment of the disclosure.

FIG. 2 is an isometric view of the battery package of FIG. 1, a computer, and a USB cable that can electrically couple the battery package to the computer.

FIG. 3 is a schematic diagram of electrical components in which embodiments of a fuel gauge may be implemented.

FIG. 4 is a schematic diagram representing embodiments of battery cell file data that are stored at a fuel gauge and viewable on a display of a computer.

FIG. 5 is an isometric view of a portable device in which battery packages in accordance with embodiments of the disclosure may be carried.

### DETAILED DESCRIPTION

Several aspects of the present disclosure are directed to devices and methods for measuring parameters corresponding to one or more battery cells within a packaged battery, for example, measuring stored charge, voltage, or current associated with the battery cells. Well-known characteristics often associated with these devices and methods have not been shown or described in detail to avoid unnecessarily obscuring the description of the various embodiments. Those of ordinary skill in the relevant art will understand that additional embodiments may be practiced without several of the details described below, and that other embodiments may include aspects in addition to those described below.

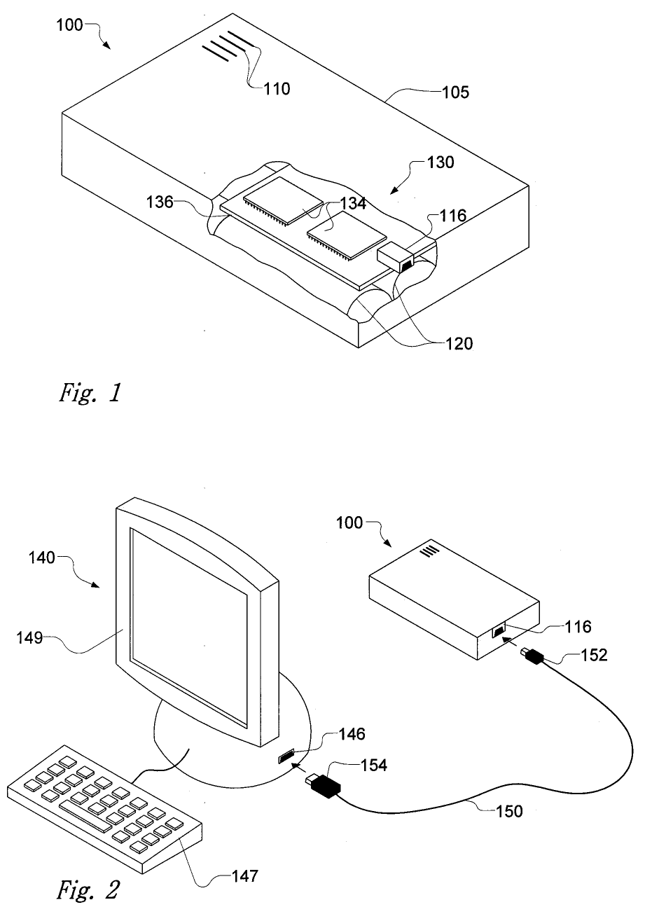

FIG. 1 is a partially cut-away, isometric view of a representative embodiment of a battery package 100 that can be operably coupled to a portable and/or external device (not shown). The battery package 100 can include a package casing or shell 105 that houses one or more battery cells 120. The package 100 may also include electrical contacts 110 located at an exterior surface of the casing 105 and coupled through the casing 105 to the battery cells 120. The electrical contacts 110, for example, can provide electrical power to a portable device that engages with the contacts 110 as described further with reference to FIG. 5. In a representative embodiment, the battery package 100 also includes a serial bus receptacle, e.g., a universal serial bus (USB) receptacle 116 that is located at and/or accessible from an exterior surface of the casing 105 and provides an electrical coupling to an interior portion of the casing 105. Within the casing 105, the USB receptacle 116 is coupled to a battery cell fuel gauge 130 that includes, for example, one or more printed circuit boards, microelectronic chips, wires or related signal paths, and/or other types of electronic circuitry. The term fuel gauge is used herein to include components that measure, detect, monitor, and/or identify parameters associated with battery cells. Such parameters may include battery energy levels and/or other information. In a particular example, the battery cell fuel gauge 130 shown in FIG. 1 can include microcontroller chips 134 that are attached to a printed circuit board 136 and electrically coupled to the battery cells 120. In further embodiments and in addition to the battery cell fuel gauge 130, the printed circuit board 136 may also carry other circuitry. For example, the printed circuit board 136 may carry resistor and/or capacitor structures (not shown) for regulating the output power of the battery cells 120.

In a particular embodiment, the fuel gauge 130 measures one or more battery cell parameters (e.g., stored energy or charge, voltage, current, and/or temperature) and produces one or more data files containing these measurements. Accordingly, the fuel gauge 130 can detect, measure and/or identify parameters directly tied to the amount of energy stored in the battery cells 120 and/or can detect, measure and/or identify other relevant parameters associated with the battery cells 120, and provide the parameters to the data files. The fuel gauge 130 can output the data files via the USB receptacle 116. Accordingly, a consumer or endpoint user of the battery package 100 can conveniently access the data files using the USB receptacle 116 as a data access port. For example, the endpoint user may use the measured battery cell parameters contained in the data files to gauge or track the performance of one or more of the battery cells 120. In another embodiment, the user may analyze the measured battery cell parameters to determine whether one or more of the battery cells 120 has a diminished operating performance or has stopped functioning altogether.

FIG. 2 is an isometric view of a host device or computer 140 that receives data files from the battery package via a USB or other serial cable 150 coupled to the USB receptacle 116. The computer 140 can include internal electronic components (not shown), such as a processor, memory, and other types of internally located hardware. The computer 140 can also include input/output devices, such as a USB receptacle 146, a keyboard 147, and a display 149. The USB cable 150 includes plugs 152 and 154 that can be electrically coupled, respectively, to the USB receptacle 116 at the battery package 100 and to the USB receptacle 146 at the computer 140. The plugs 152 and 154 can comprise a variety of plug shapes, including those of micro and mini USB plugs and A- and B-type USB plugs. The receptacles 116 and 146 can accordingly have a receptacle shape that corresponds to the specific plug shape of the plugs 152 and 154. In many embodiments, the size and shape of the plugs 152 and 154 may depend on the locations of the corresponding receptacles 116 and 146. For example, the battery package receptacle 116 can be shaped to accept small and compact mini USB plugs and the host device receptacle 146 can be shaped to accept (larger) A-type USB plugs.

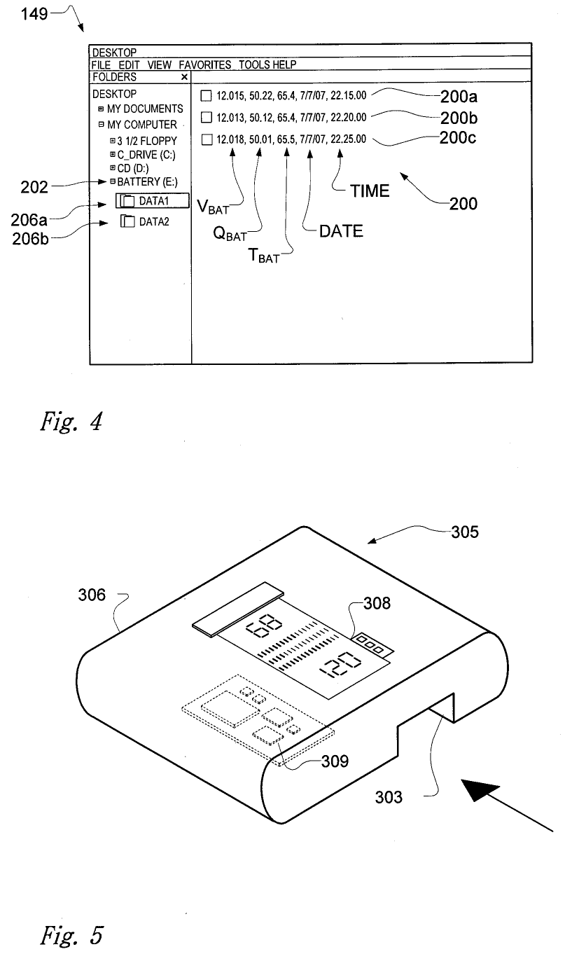

In many embodiments, the battery package 100 operates as a mass storage class (MSC) device (also referred to as USB mass storage (UMS) device) when coupled to the computer 140, and presents itself to the computer 140 as such. The term MSC relates to a generic or native USB communication standard that describes how MSC devices are to present themselves to a host device (i.e., a computer) as a simple data store that can be accessed using commonly available device drivers at the host device (for more details see Universal Serial Bus Mass Storage Class Specification Overview Revision 1.2 USB Implementers Forum Jun. 23, 2003 pp. 1-7). Accordingly, the computer 140 can use native and/or commonly available USB drivers to interface with the fuel gauge 130 of the battery package 100, and can access one or more data files corresponding to the measured parameters of the battery cells 120. For example, when coupled to the computer 140 via the USB cable 150, the battery package 100 may present itself to the computer 140 as an independent data drive having a displayable icon with an assigned drive letter. When displayed at the display 149, the drive may show that it contains one or more data files containing the measured battery cell parameters. In several embodiments, these data files may have filenames that represent the battery cell data itself (described further with reference to FIG. 4). In this embodiment and others, data files can also have other types of names and/or may store the measured battery cell parameters in a variety of file formats. For example, data files can include well-known file formats, such as .txt, .doc, .xls, or .jpg files.

In contrast to embodiments of the battery package 100, conventional battery cell packages (employing conventional battery cell fuel gauges) typically do not provide USB access to measured battery cell parameters stored at the fuel gauge. Instead, conventional fuel gauges can primarily only communicate internally with other battery package components using system management buses (SMBuses) or related types of I2C buses. These buses provide simple two-wire access to memory registers that are located within the conventional fuel gauge, and these buses generally have small bandwidths. For example, in a personal computer, SMBuses are often used to communicate with relatively simple components, such as lid switches and temperature, fan, and voltage sensors. Similarly, conventional battery packages typically use the SMBus to internally communicate basic feedback signals from the battery cell fuel gauge. For example, conventional fuel gauges may be pre-programmed to produce a feedback signal indicative of battery cell overheating (i.e., when battery temperature measurements exceed certain temperature values). When such a signal is generated, a battery package may accordingly remove output power, but the measured values of battery cell temperature are typically not reported in an external manner (e.g., to devices that are receiving power from the battery package).

In some implementations, battery cell data can be accessed using external hardware that intermediates between a host device and the SMBus or I2C bus of a conventional battery fuel gauge. However, this intermediary hardware and/or its related software are typically proprietary and not readily available or affordable to the consumers or endpoint users of conventional battery packages. Instead, it is generally only available to battery package manufacturers, and therefore they are the only ones that can retrieve battery cell data. This means that when conventional battery packages fail or stop functioning correctly, endpoint users typically cannot access the measured battery cell parameters. Thus, endpoint users cannot determine the battery package failure mode or whether the battery package is repairable. Such users must then either discard the battery package or return the battery package to the manufacturer to determine whether the battery package is repairable. In the first case and if there is no warranty in place, the endpoint user must often absorb the cost associated with replacing the battery package. In the latter case, the manufacturer and/or the endpoint user must absorb the cost of shipping and returning battery packages to the manufacturer.

Embodiments of the battery package 100, however, allow consumers and/or other endpoint users of the battery package to access measured battery cell parameters at the fuel gauge 130 without the need for intermediary hardware and related software, except for readily available USB cables. For example, a user of the battery package 100 can connect the USB cable 150 (FIG. 2) to the USB receptacle 116 and the corresponding receptacle on his/her personal computer for direct access to data files (containing the measured battery cell parameters) at the fuel gauge 130. In a particular example, the direct access is obtained without the need for an additional intermediate device, e.g., a device that translates or transforms the data to a computer-readable format. Because the fuel gauge 130 provides a USB interface that can be accessed using native or MSC-based USB drivers, most users do not need to install any additional software on their personal computers because most native and MSC-based USB drivers are included with modern operating systems, such as Windows XP® and MAC OS X®. If a user does not have these native drivers, they can be easily obtained as they are free and widely available via the Internet. Besides being easy to access, the data files can also have well-known file formats or data that are presented in the filename of an individual data file, eliminating the need for any additional or expensive application software to be installed at the computer 140. Accordingly, in the foregoing embodiments, the user can access (e.g., obtain meaningful data from) the data files with non-proprietary hardware and/or software. As used herein, non-proprietary hardware and/or software refers generally to hardware and/or software that is included with or is readily available or accessible via a standard operating system (e.g., a typical PC operating system) without extra charge, as opposed to software and/or hardware that is or must be separately purchased.

Further, embodiments of the battery package 100 also enable endpoint users and/or manufacturers to more readily troubleshoot and/or assess the performance the battery package. For example, the endpoint user can report performance data over a manufacturer-provided hotline or webpage, bypassing the need to return the battery package 100 to the manufacturer. The manufacturer can then use the battery cell data to determine whether the battery package can be readily repaired, or whether the endpoint user should receive a replacement battery package. Thus, the manufacturer and/or endpoint user can eliminate the expense associated with shipping and returning battery packages to the manufacturer.

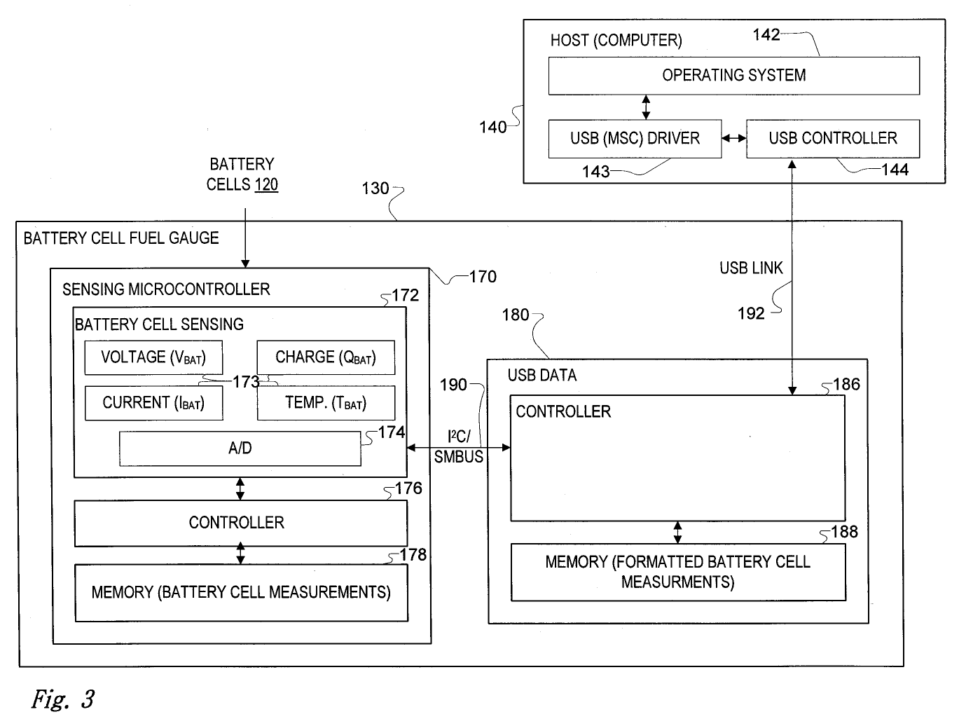

FIG. 3 is a block diagram showing components of a particular embodiment of the fuel gauge 130 in more detail. The fuel gauge 130 includes a first (sensing) microcontroller 170 electrically coupled to the battery cells 120, and a second (USB data) microcontroller 180 coupled to the first microcontroller 170 via an I2C/SMBus link 190. The computer 140 can be coupled to the second microcontroller via a USB link 192 provided by the USB cable 150 (FIG. 2). The computer 140 can include an operating system 142, a native or MSC-USB-based driver 143, and a USB controller 144 for communicating with the second microcontroller 180 over the USB link 192. For example, the USB driver 143 drives the USB controller 144 transferring data files (containing measured battery cell parameters) from the second microcontroller 180 to the computer 140 via the USB link 192.

The first microcontroller 170 can include a battery cell sensing circuit 172, a controller 176, and a memory 178, all of which can be intercoupled, for example, by SMBus or I2C busses or other types of signal paths. The sensing circuit 172 can include a variety of analog circuits 173 that provide specific battery cells measurements, such as instantaneous voltage VBAT and current IBAT, remaining charge QBAT, and temperature TBAT. The sensing circuit 172 may also include an analog-to-digital converter 174 that converts analog measurements into digital signals that are communicated to the memory 178 via the controller 174. The controller 174 can include a processor (not shown) for executing program instructions (e.g., stored at the memory 178 or within a memory associated with the controller) that direct the controller 174 to store the battery cell measurements of the sensing circuit 172 at the memory 178. Such a processor can also execute other types of program instructions, such as those for communicating with the second microcontroller 180 over the I2C/SMBus link 190. The memory 178 may be a non-volatile memory, including EEPROM and flash, having memory registers for storing individual battery cell measurements (not shown).

The second microcontroller 180 can include a controller 186 and a memory 188, which, similar to the first microcontroller 170, can be intercoupled by SMBus or I2C busses or other types of signal paths. The controller 186 can include a processor (not shown) for executing processing instructions (e.g., stored at the memory 188 or within a memory associated with the controller) that directs the controller to communicate with the first microcontroller 170 over the I2C/SMBus link 190 and for communicating with the computer 140 over the USB link 192. Such a processor can also execute processing instructions for storing the battery cell measurements (stored at the memory 188) into a file format that is readable by the computer 140. Similar to the first microcontroller memory 178, the second microcontroller memory 188 can include a non-volatile memory, including EEPROM and flash.

In other embodiments, it will be appreciated that several or all of the features described above with respect to the first and second microcontrollers 170, 180 can be combined and/or included with a single microcontroller or other type of processing device that is disposed within the battery package 100 and coupled to the battery cells 120 and the computer 140. For example, such a device may include a single, centralized controller or processor. In such an embodiment, the I2C/SMBus link 190 can be omitted and/or the battery cell measurements and corresponding data files may be stored in a common memory component.

FIG. 4 is a schematic diagram illustrating an embodiment of the data files 200 (represented individually by reference numbers 200a-c) that are retrievable from the fuel gauge 130 (FIGS. 1 and 3) and displayed at the display 149 of the computer 140 (FIG. 2). When the battery package 100 is coupled to the computer 140, a removable drive icon and/or letter 202 corresponding to the battery package appears on the display 149. Accordingly, a user can then navigate to the data files 200, which, for example, can be stored in a subfolder 206a. In other examples, the data files 200 can be stored in another location, such as a subfolder 206b or in the root directory of the removable drive 202.

In the embodiment shown in FIG. 4, the battery cell measurements are represented in the filenames of the data files 200. For example, the filenames of the data files 200 include measurements associated with voltage, stored charge, and temperature (i.e., V_{BAT}, Q_{BAT}, and T_{BAT}). Accordingly, the filetype of the data files 200 can be irrelevant. For example, a user can note measured battery cell parameters as they are presented in the filename without ever having to run application software. Furthermore, the filenames of the data files 200 can also include the date and time corresponding to when specific battery cell measurements were taken. In other examples, the data files 200 can include a variety of filetypes. As such, the measured battery cell parameters can be contained within individual data files 200 and accordingly accessed upon running application software corresponding to a specific file type. For example, if the data files 200 are .xls files, Microsoft Excel can be used to view battery cell measurements. Further, individual data files 200 can contain one or more sets of time-stamped and/or aggregated battery cell data. For example, individual data files 200 can contain battery cell parameters that are measured at numerous sampling times during intervals that include hours, days, weeks, months, etc. Table 1 (below) shows various embodiments of registers that can be employed by the fuel gauge 130 (FIGS. 1 and 3) to display corresponding battery cell measurements at the display 149. Table 1 also shows embodiments of registers than can be manipulated by a user, for example via the computer 140 (FIG. 2).

TABLE 1

| Example fuel | Example fuel gauge registers that |
|---|---|
| gauge registers: | can be user-manipulated: |
| Voltage | Operation Configuration Registers |
| Current | (Certain bits only) |
| Temperature | LED Configuration registers |
| State of Charge | Charge Control Registers |
| Remaining Capacity | (Limited access) |
| Full Charge Capacity | |
| Design Capacity | |
| Time to Empty | |
| Time to Full | |
| Cycle Count | |
| Battery Status | |
| Manufacture Date | |
| Serial Number | |
| Pack Lot Code | |
| Lifetime Max Temp | |
| Lifetime Min Temp | |
| Lifetime Max Voltage | |
| Lifetime Min Voltage | |
| Lifetime Max Current | |

Embodiments of the data files 206 can also store different types of measurements or have different combinations of values in the corresponding filenames of the data files. In many examples, the data files 200 may include more or fewer files which can be based on the frequency at which these files are created. For example, the data files 200 may be periodically updated with a new file at an interval that is user-determined or an interval that is pre-programmed into the fuel gauge 130. In several embodiments, the rate at which the data files 200 are updated may be based on the data transmission rates associated with the (limited speed) I²C/SMBus signal paths of the first and second microcontrollers 170, 180 and/or the I²C/SMBus link 190 (FIG. 3).

In addition to providing USB-accessible battery cell file data, embodiments of the fuel gauge 130 may also be used to provide various other functions within the battery package 100. For example, the fuel gauge 130 may be configured to recharge the battery cells 120 using power that is received at the USB receptacle 116 and output by the computer 140 over the USB cable 150 (FIG. 2). Also, the fuel gauge 130 can be configured to provide other types of data in addition to or in lieu of those relating to the measurements corresponding to the battery cells 120. For example, the fuel gauge 130 may output data corresponding to the model and/or serial number of the battery package 100. The model number, serial number, or other type of identifier can be used, for example, by a manufacturer to identify particular features or parts associated within the battery package 100, such as whether the battery cells 120 are nickel-cadmium or lithium-ion type batteries. In further examples, the fuel gauge 130 may allow a user to transfer data from the computer 140 to either or both of the memories 170, 180 described above with reference to FIG. 3. For example, a user can store configuration data at the fuel gauge 130 that indicates specific battery parameters that should be measured and/or intervals at which battery cell parameters should be measured. Additionally or alternatively, a user may also manage certain features of the fuel gauge 130 via the USB receptacle 116. For example, a user can toggle whether the battery package 100 automatically recharges (e.g., when it is coupled to the computer 140) or whether the battery package 100 only recharges when the battery cells 120 have discharged to a threshold level.

Battery packages that include a fuel gauge having any of the foregoing features can be coupled to a variety of portable electronic devices. For example, FIG. 5 illustrates a portable device 305 having a housing body 306 that includes external electronic components 308 (e.g., an LED display and related controls) accessible from an exterior surface of the housing body 306, and internal electronic components 309 (e.g., a printed circuit board, a microelectronic chip, a wire or related signal path, and/or other types of electronic circuitry) disposed within the housing body 306. The portable device 305 can also include a battery package slot 303. A battery package having any of the foregoing features can be inserted into the slot 303. For example, the electrical contacts 110 (FIG. 1) of the battery package 100 can be positioned so that battery cells 120 are electrically coupled to the portable device 305 so as to provide power to the portable device, including power provided to the internal and external electronic components 308 and 309.

From the foregoing, it will be appreciated that representative embodiments have been described herein for purposes of illustration, but that various modifications may be made to these embodiments, including adding and/or eliminating particular features. For example, the fuel gauge 130 may be configured to measure a variety of battery cell parameters, in addition to or in lieu of voltage, current, temperature, and remaining charge. Also, certain battery cell measurements can be combined to create other battery cell measurements. For example, instantaneous power can be derived using voltage and current measurements. In addition, the fuel gauge 130 may store such measurements at any of a variety of data capturing intervals. For example certain battery cell measurements may be taken more or less frequently than other battery cell measurements. While representative examples of data transfer of battery cell fuels gauges were described above in the context of USB-based communications, other embodiments may include other types of serial communication standards, such as those of IEEE 1394 (also called “FireWire” or “i.Link”), and/or wireless communications. Further, while advantages associated with certain embodiments have been described in the context of those embodiments, other embodiments may also exhibit such advantages, and not all embodiments need necessarily exhibit such advantages to fall within the scope of the invention.

I/We claim:

1. A battery pack comprising:
a casing;
at least one battery cell disposed within the casing;
a universal serial bus (USB) receptacle accessible from an exterior surface of the casing and providing an electrical coupling to an interior portion within the casing; and
a battery cell fuel gauge disposed within the casing and coupled to the USB receptacle and the battery cell, the fuel gauge including a processor and a memory, wherein the processor is configured to:
detect at least one battery cell parameter associated with the operation of the battery cell;
generate at least one data file based on the detected battery cell parameters; and
provide the data file to a host device coupled to the USB receptacle, wherein the battery package is configured to operate as a mass storage class (MSC) device.

2. The battery pack of claim 1, wherein the battery cell parameter is one of a voltage of the battery cell, a temperature of the battery cell, a stored energy of the battery cell, and a current produced by the battery cell.

3. The battery pack of claim 1, wherein generating at least one data file comprises:
determining a file name based at least in part on the detected parameter, with the file name conveying the value of the detected parameter; and
storing the data file using the determined file name.

4. The battery pack of claim 1, wherein the processor is further configured to:
receive information from the host device specifying a sensing time interval;
wherein detecting the battery cell parameter comprises detecting instantaneous values of the battery cell parameter at times based on the specified sensing time interval.

5. A method for operating a battery cell fuel gauge, the method comprising:
detecting one or more parameters corresponding to one or more battery cells that are disposed within a casing of a battery package with a fuel gauge that is also disposed within the casing and that is electrically coupled to a data connector that is accessible from outside the casing;
formatting the detected one or more parameters into a data file that is readable with non-proprietary hardware and/or software;
storing the data file at the fuel gauge; and
providing a host device with access to the data file via the data connector.

6. The method of claim 5, wherein the data file is readable with an MSC-based USB driver.

7. The method of claim 5, wherein detecting one or more parameters comprises detecting multiple values of the one or more parameters at multiple times based on a specified time interval and wherein formatting the detected one or more parameters into a data file comprises generating a data file containing the multiple values and the associated multiple times.

8. The method of claim 5, wherein the data file is a first data file and wherein the method further comprises:
determining one or more manufacturing parameters associated with the one or more battery cells, wherein the one or more manufacturing parameters includes at least one of a model number, a serial number, a pack lot code, a manufacture date, and a battery cell type; and
formatting the one or more manufacturing parameters into a second data file;
storing the second data file at the fuel gauge; and
providing the host device with access to the second data file.

9. The method of claim 5, wherein storing the data file comprises:
determining a file name based at least in part on at least one of the detected parameters with the file name conveying the value of the at least one of the detected parameters; and
storing the data file using the determined file name.

10. The method of claim 5, further comprising:
receiving information from the host device specifying a sensing time interval;
wherein detecting one or more parameters comprises detecting instantaneous values of the one or more parameters at times based on the specified sensing time interval.

11. The method of claim 5, wherein the data connector is a serial bus connector and providing the host device with access to the data file via the data connector comprises presenting the battery package to the host device as a mass storage class (MSC) device.

12. An apparatus comprising:
at least one battery cell;
a casing housing the at least one battery cell and including an exterior surface having electrical contacts that are coupled through the casing to the at least one battery cell;
a serial bus receptacle at least partially disposed within the casing and accessible from outside the casing;
a sensing component located within the casing and configured to detect at a first time a first value of a parameter associated with the at least one battery cell, and to detect at a second time a second value of the parameter, wherein the second time occurs a specified time interval after the first time; and
a data component disposed within the casing and configured to store the first value and the second value in a data file, the data file being readable with non-proprietary hardware and/or software, and to provide the data file to a host device connected to the serial bus receptacle.

13. The apparatus of claim 12, wherein the serial bus receptacle is a universal serial bus connector and the apparatus is configured to operate as a mass storage class device.

14. The apparatus of claim 12, wherein the parameter associated with the battery cell is one of a voltage of the at least one battery cell, a temperature of the at least one battery cell, a stored energy of the at least one battery cell, or a current produced by the at least one battery cell.

15. The apparatus of claim 12, wherein the data component is further configured to receive data from the host device defining the specified time interval and wherein the data component is further configured to store the first time and the second time in the data file.

16. The apparatus of claim 12, wherein the sensing component is configured to detect multiple parameters associated with the at least one battery cell and the data component is further configured to receive data from the host device selecting an individual parameter to detect from the multiple parameters.

17. The apparatus of claim 12, wherein the data file has an associated file name based at least in part on the first value, the first time, the second value, or the second time.

18. The apparatus of claim 12, wherein the serial bus receptacle is configured to receive power from the from the host device and to provide the received power to recharge the at least one battery cells.

19. The apparatus of claim 12, wherein the data component is further configured to generate a third value of a derived parameter based on the first value and the second value and to store the third value in the data file.

20. An apparatus for operating a battery cell fuel gauge, the apparatus comprising:
one or more battery cells;
carrying means for carrying the one or more battery cells;
detecting means for detecting at least one parameter corresponding to the one or more battery cells;
formatting means for formatting the detected parameters into a data file;
storing means for storing the data file at the fuel gauge, the data file being readable with non-proprietary software and/or hardware; and
access means for providing a host device with access to the data file.

21. The apparatus of claim 20, wherein the parameter comprises at least one of a voltage of the battery cell, a temperature of the battery cell, a stored energy of the battery cell, a current produced by the battery cell, a remaining capacity, a full charge capacity, a time to empty, a time to full, a lifetime maximum temperature, a lifetime minimum temperature, a lifetime maximum current, or a lifetime minimum current.

22. The apparatus of claim 20, further comprising:
determining means for determining one or more manufacturing parameters associated with the one or more battery cells, wherein the one or more manufacturing parameters includes at least one of a model number, a serial number, a pack lot code, a manufacture date, or a battery cell type; and
wherein
the formatting means formats the one or more manufacturing parameters into a second data file;
the storing means stores the second data file at the fuel gauge; and
the access means provides the host device with access to the second data file.

23. The apparatus of claim 20, further comprising:
receiving means for receiving information from the host device specifying a sensing time interval;
wherein the detection means comprises a means for detecting instantaneous values of the at least one parameter at the specified sensing time interval.

24. The apparatus of claim 20, further comprising receiving means for receiving information from the host device that selects an individual parameter to detect from the at least one parameter.

25. The apparatus of claim 20, further comprising generation means for generating a derived parameter based on the detected at least one parameter, wherein the means for formatting is further configured to format the derived parameter into the data file.

26. The apparatus of claim 20 wherein the data file is readable with an MSC-based USB driver.
